(19) United States
(12) Patent Application Publication
(10) Pub. No.: US 2017/0286959 A1
(43) Pub. Date: Oct. 5, 2017

(54) SYSTEMS AND METHODS FOR VERIFYING AN IDENTITY RECORD

(71) Applicants: David Thomas, Cape Town (ZA); Juan Furmie, Cape Town (ZA)

(72) Inventors: David Thomas, Cape Town (ZA); Juan Furmie, Cape Town (ZA); Mark Anthony James Chirnside, Cape Town (ZA)

(73) Assignees: David Thomas, Cape Town (ZA); Juan Furmie, Cape Town (ZA)

(21) Appl. No.: 15/513,585

(22) PCT Filed: Sep. 23, 2015
(86) PCT No.: PCT/IB2015/057334

§ 371 Date: Mar. 23, 2017

(30) Foreign Application Priority Data
Sep. 23, 2014 (ZA) 2014/06935

(51) Int. Cl. G06Q 20/40; H04L 29/06

(52) U.S. Cl. CPC G06Q 20/4014; H04L 63/102; H04L 63/083

(57) ABSTRACT

A system and method for verifying an identity record is provided. The system includes a data server configured to submit first and second data elements associated with an unverified identity record to first and second third party servers, respectively. The data server then receives from the first and second third party servers, at least one additional data element and at least one further data element being associated, at the first and second third party servers respectively, with the first and second data elements. A comparing component then compares the received at least one additional data element and at least one further data element with at least corresponding data elements associated with the identity record and a flagging component flags the identity record as a verified identity record if the received at least one additional and further data elements match the at least one corresponding data element.

### CROSS-REFERENCE TO RELATED APPLICATIONS

This application claims priority from South African provisional patent application number 2014/06935 filed on 23 Sep. 2014, which is incorporated by reference herein.

### FIELD OF THE INVENTION

This invention relates to systems and methods for verifying an identity record.

### BACKGROUND TO THE INVENTION

“Know your customer” (KYC) typically refers to the processes used by an entity to verify the identities of their consumers. Such processes are often required by legislation compelling entities to adequately identify their consumers.

In South Africa, for example, the Financial Intelligence Centre Act (“FICA”) requires accountable institutions to collect, in the case of natural persons, identity proving documents and documents proving proof of the consumer's residential address. For example, the consumer may have to provide a copy of an identity document issued by the Republic of South Africa as well as a utility bill, such as water, electricity or rates (less than 3 months old), a bank statement or financial statement from another financial institution, a copy of a signed lease agreement (less than 1 year old), a municipal rates and taxes invoice (less than 3 months old) or the like.

A problem associated with KYC requirements is that consumers are required to provide such documents to each and every institution with whom they wish to transact. This can be an administrative burden and may only increase the irritation experienced by consumers in attempting to go about their business.

In addition, providers of ecommerce services are generally not able to easily verify that the individuals or entities with whom they transact are in fact who they purport to be. As a result, fraudulent ecommerce transactions are rife and a need exists for a way of verifying the identities of consumers of ecommerce service providers in a way that does not place an undue administrative burden on the service provider or consumer.

There is accordingly a need for a solution which solves this and/or other problems, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with a first aspect of the invention there is provided a method for verifying an identity record, the method being conducted at a data server and comprising the steps of:
submitting, by a submitting component, a first data element associated with an unverified identity record to a first third party server;
   receiving, by a receiving component, from the first third party server, at least one additional data element being associated, at the first third party server, with the first data element;
submitting, by the submitting component, a second data element associated with the unverified identity record to a second third party server;
   receiving, by the receiving component, from the second third party server, at least one further data element being associated, at the second third party server, with the second data element;
   comparing, by a comparing component, the received at least one additional data element and the received at least one further data element with at least corresponding data elements associated with the unverified identity record; and,
   if the received at least one additional data element and the received at least one further data element matches the at least corresponding data elements, flagging, by a flagging component, the identity record as a verified identity record.

Further features provide for the step of comparing the received data elements with corresponding data elements to include:
associating, by a confidence associating component, a confidence indicator with the identity record, wherein the confidence indicator is related to the extent to which the received data elements match the corresponding data elements; and,
flagging, by the flagging component, the identity record as a verified identity record if the confidence indicator exceeds a predetermined threshold.

A still further feature provides for the identity record to have associated therewith one or more data elements of the group of: a full name; initials; national identity number; a residential address; a communication address; and payment credentials including a bank account number, a branch code and an account type.

Even further features provide for the first data element to be a national identity number and for the received at least one additional data element to include one or more of the group of: a full name; initials; living/deceased status; residential address; and marital status.

Further features provide for the second data element to be payment credentials; for the received at least one further data element to include one or more of the group of: a full name; initials; residential address; national identity number; and a status of an associated financial account.

Still further features provide for the method to include steps of:
initiating, by an initiating component, a payment having a specific attribute in favour of the financial account associated with the payment credentials;
receiving, by a receiving component, from a communication device of a user, an indication of an attribute in respect of the payment made in favour of the financial account, the user having obtained the attribute from a bank statement or other transaction record relating to the financial account and accessible by the user;
comparing, by a comparing component, the received attribute to the specific attribute; and,
if the received attribute matches the specific attribute, authenticating the identity record.

A yet further feature provides for the specific attribute to be one or both of a specific amount and a specific payment reference; and for the payment reference to be unique to the user.

Further features provide for the method to include further steps of:
receiving, by a receiving component, from a utility provider, a utility bill associated with at least one data element of the identity record;
validating, by a validating component, using a residential address provided with the utility bill, the residential address associated with the identity record;
identifying, by an identifying component, utility usage intimating user activity at the residential address; and,
flagging, by a flagging component, for a predefined period, the residential address as active.

In accordance with a second aspect of the invention there is provided a system for verifying an identity record, the system including a data server comprising:
a submitting component for submitting first and second data elements associated with an unverified identity record to first and second third party servers;
a receiving component for receiving, from the first and second third party servers, at least one additional data element and at least one further data element being associated, at the first and second third party servers respectively, with the first data element;
a comparing component for comparing the received at least one additional data element and at least one further data element with at least corresponding data elements associated with the identity record; and,
a flagging component for, if the received at least one additional and further data elements match the at least one corresponding data element, flagging the identity record as a verified identity record.

A further feature provides for the data server to include an extracting component for extracting the first data element from the identity record.

Yet further features provide for the comparing component to include a confidence associating component for associating a confidence indicator with the identity record, for the confidence indicator to be related to the extent to which the received data elements, including at least the additional and further data elements, match corresponding data elements; and, for the flagging component to, if the confidence indicator exceeds a predetermined threshold, flag the identity record as a verified identity record.

An even further feature provides for the identity record to have associated therewith one or more data elements of the group of: a full name; initials; national identity number; a residential address; a communication address; and payment credentials including a bank account number, a branch code and an account type.

Further features provide for the first data element to be a national identity number and for the received at least one additional data element to include one or more of the group of: a full name; initials; living/deceased status; residential address; and marital status.

Still further features provide for the second data element to be payment credentials; for the received at least one further data element to include one or more of the group of: a full name; initials; residential address; national identity number; and a status of an associated financial account.

Yet further features provide for the data server further to include an initiating component for initiating a payment having a specific attribute in favour of the financial account associated with the payment credentials; an indication receiving component for receiving, from a communication device of a user, an indication of an attribute in respect of the payment made in favour of the financial account, the user having obtained the attribute from a bank statement or other transaction record relating to the financial account and accessible by the user; an attribute comparing component for comparing the received attribute to the specific attribute; and, an authenticating component for, if the received attribute matches the specific attribute, authenticating the identity record.

A further feature provides for the specific attribute to be one or both of a specific amount and a specific payment reference; and for the payment reference to be unique to the user.

Yet further features provide for the data server further to include a utility bill receiving component for receiving, from a utility provider, a utility bill associated with at least one data element of the identity record; a validating component for validating, using a residential address provided with the utility bill, the residential address associated with the identity record; an identifying component for identifying utility usage intimating user activity at the residential address; and, for the flagging component to flag, for a predefined period, the residential address as active.

In accordance with a third aspect of the invention, there is provided a computer program product for verifying an identity record, the computer program product comprising a computer-readable medium having stored computer-readable program code for performing the steps of:
submitting a first data element associated with an unverified identity record to a first third party server;
   receiving, from the first third party server, at least one additional data element being associated, at the first third party server, with the first data element;
submitting a second data element associated with the unverified identity record to a second third party server;
   receiving, from the second third party server, at least one further data element being associated, at the second third party server, with the second data element;
   comparing the received at least one additional data element and the received at least one further data element with at least corresponding data elements associated with the unverified identity record; and,
   if the received at least one additional data element and the received at least one further data element matches the at least corresponding data element, flagging the identity record as a verified identity record.

Further features provide for the computer-readable medium to be a non-transitory computer-readable medium and for the computer-readable program code to be executable by a processing circuit.

An embodiment of the invention will now be described, by way of example only, with reference to the accompanying drawings.

### BRIEF DESCRIPTION OF THE DRAWINGS

In the drawings:

FIG. 1 is a schematic diagram which illustrates an exemplary system for verifying an identity record;

FIG. 2 is a block diagram which illustrates components of a system for verifying an identity record;

FIG. 3A is a swim-lane flow diagram which illustrates exemplary methods for verifying an identity record;

FIG. 3B is a flow diagram which illustrates further method steps for periodically updating the validity of a residential address;

FIG. 4 illustrates an example of a server system in which various aspects of the disclosure may be implemented; and,

FIG. 5 shows a block diagram of a communication device that may be used in embodiments of the disclosure.

### DETAILED DESCRIPTION WITH REFERENCE TO THE DRAWINGS

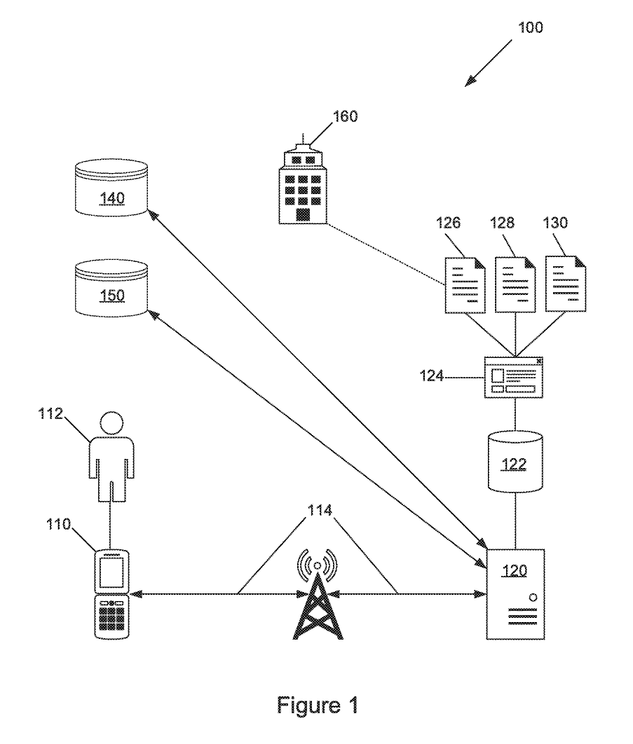

FIG. 1 is a schematic diagram which illustrates an exemplary system (100) for verifying an identity record. The system (100) includes a communication device (110) of a user (112) and a data server (120). The system (100) further includes a first third party server (140), a second third party server (150), and a utility provider (160).

The communication device (110) may be any appropriate device capable of communicating over a communications network. Exemplary communication devices include: laptop computers; tablet computers; desktop computers; smart phones; smart appliances and the like. In the illustrated system (100), the communication device (110) communicates with the data server (120) via a communications network (114) which may, for example, be the Internet. Accordingly, the communication device (110) may be able to transmit and receive data packets to and from the data server (120). This enables the user (112) to transmit requests, messages, information and the like to the data server (120) via the communications network (114).

The data server (120) may be any appropriate server computer, distributed server computer, cloud-based server computer, server computer cluster or the like. The data server (120) maintains a database (122) in which an identity record (124) is stored. The identity record (124) is a database record having a number of data elements (126, 128 and 130) associated therewith. The data elements (126, 128 and 130) may be provided by the user (110) at a registration phase and may include one or more of the group of: a full name; initials; a national identity number; a residential address; a communication address; and payment credentials including a bank account number, a branch code and an account type.

The data server (120) is configured to receive data elements (126, 128 and 130) from a user via the user's communication device (110) and associate the data elements (126, 128 and 130) with the identity record (124). The data server (120) is also configured to verify the identity record (124) by querying one or both of the first third party server (140) and second third party server (150).

It may be the case that exact matches between data elements (126, 128 and 130) associated with the data record (124) and data elements received from the first or second third party server (140, 150) are not required. In some cases, the data server (120) associates a confidence indicator with the identity record (124) which is related to the extent to which the received data elements match corresponding data elements (126, 128 and 130) associated with the data record (124). As such, the identity record (124) may be verified if the confidence indicator exceeds a predetermined threshold.

In some embodiments, the data server (120) may authenticate the identity record (124), and in particular payment credentials associated with the identity record (124), by initiating a payment having a specific attribute in favour of a financial account associated with the payment credentials.

Furthermore, the data server (120) may receive a utility bill associated with at least one data element (126, 128 and 130) from the utility provider (160). The data server (120) may use the utility bill to validate the residential address associated with the identity record (124) and may also identify utility usage intimating user activity at the residential address. The data server (120) may do this periodically, for example every three months, so as to flag the residential address as being active for that period. Exemplary utility providers include a fixed-line telephone provider, an electricity utility, a water utility, a gas utility and the like.

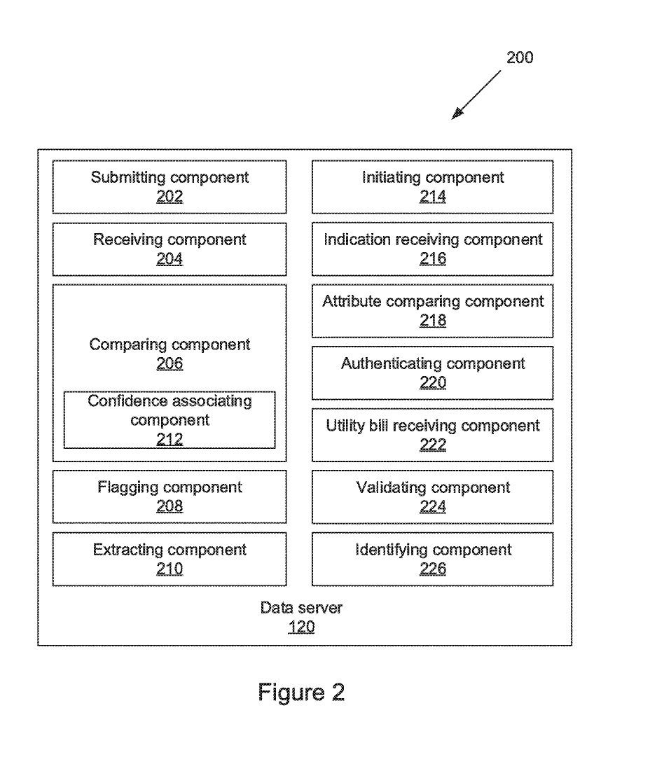

FIG. 2 is a block diagram which illustrates components of a system (200) for verifying an identity record.

The system (200) includes a data server (120) having a submitting component (202) for submitting a first data element associated with an unverified identity record to a first third party server.

The data server (120) also includes a receiving component (204) for receiving, from the first third party server, at least one additional data element being associated, at the first third party server, with the first data element.

The data server (120) includes a comparing component (206) for comparing the received at least one additional data element with at least one corresponding data element associated with the identity record.

In addition, the data server (120) includes a flagging component (208) for, if the received at least one additional data element matches the at least one corresponding data element, flagging the identity record as a verified identity record.

The data server (120) includes an extracting component (210) for extracting the first data element from the identity record.

In some embodiments, the submitting component (202) is also for submitting a second data element associated with the identity record to a second third party server. Similarly, the receiving component (204) receives, from the second third party server, at least one further data element being associated with the second data element at the second third party server. The comparing component (206) accordingly compares the received at least one further data element with at least one corresponding data element associated with the identity record in addition to comparing the received at least one additional data element with at least one corresponding data element.

Embodiments also provide for the comparing component (206) to include a confidence associating component (212) for associating a confidence indicator with the identity record. The confidence indicator is related to the extent to which the received data elements match corresponding data elements. The flagging component (208) flags the identity record as a verified identity record if the confidence indicator exceeds a predetermined threshold.

Some embodiments provide for the data server (120) to include an initiating component (214) for initiating a payment having a specific attribute in favour of a financial account associated with payment credentials associated with the identity record. An indication receiving component (216) is also provided for receiving, from a communication device of a user, an indication of an attribute in respect of the payment made in favour of the financial account. The user may obtain the attribute from a bank statement, most likely an online bank statement or other transaction record, relating to the financial account. An attribute comparing component (218) compares the received attribute to the specific attribute and an authenticating component (220) authenticates the identity record if the received attribute matches the specific attribute. The specific attribute may be one or both of a specific amount and a specific payment reference. The payment reference may be unique to the user.

The data server (120) may also include a utility bill receiving component (222) for receiving, from a utility provider, a utility bill associated with at least one data element of the identity record. A validating component (224) may validate, using a residential address provided with the utility bill, the residential address associated with the identity record. Furthermore, an identifying component (226) may identify utility usage intimating user activity at the residential address. The flagging component (208) flags, for a predefined period, the residential address as active. At expiration of the predefined period, the data server (120) may request an updated utility bill to once again validate the residential address and flag it as being active.

In order to use the systems described above, a user initially registers an identity record with a data server using his or her communication device. The user may provide a communication address (for example an email address), a passcode and a country in which the user resides which are then associated with the identity record. The user may be required to verify the communication address by following a link included in a message sent to the communication device using the communication address.

Once the communication address has been registered, the user provides a full name of the user, a date of birth of the user and national identity number (or passport number, social security number, or the like) to the data server whereat they are associated with the identity record. The user also supplies payment credentials, including for example an account number, a branch code and an account type which are also associated with the identity record. It will be appreciated that the information and payment credentials provided by the user may be automatically gathered by optical scanning and optical character recognition hardware and software resident on the user's communication device, after which they may be automatically transmitted to the data server. Such optical scanning may conducted from official, preferably government issued identification documents such as, for example, passports and identity documents or cards, and payment instruments such as credit/debit cards and the like.

Up until this point, the identity record is flagged as ‘unverified’ meaning that none of the information, apart from potentially the user's communication address, has been verified. Embodiments of the described systems and methods enable verification of the identity record. The identity record may have, associated therewith, one or more data elements of the group of: a full name; initials; national identity number; a residential address; a communication address; and payment credentials including a bank account number, a branch code and an account type.

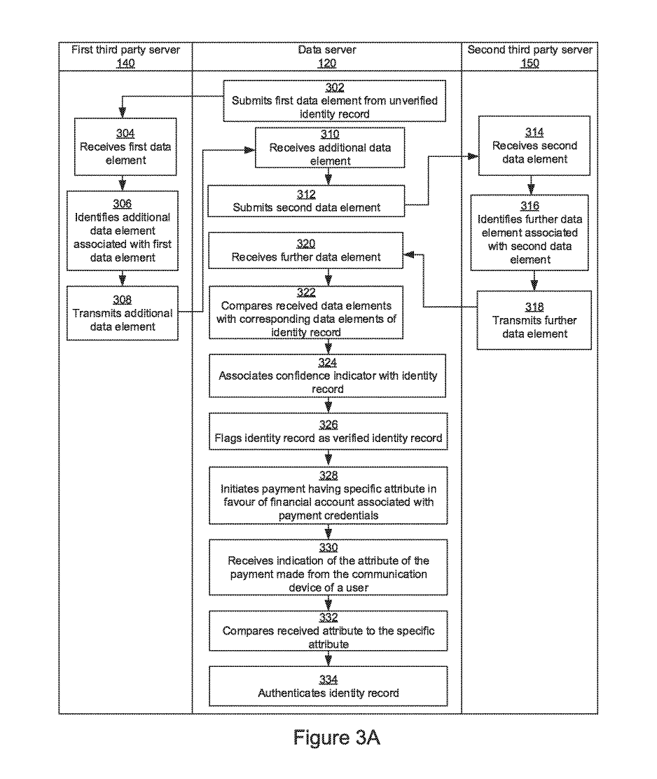

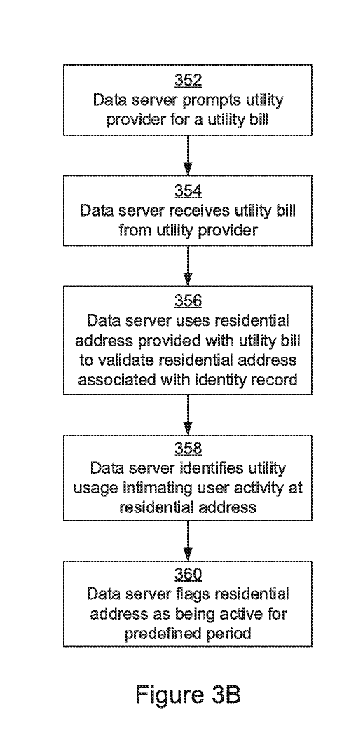

FIG. 3A is a swim-lane flow diagram which illustrates exemplary methods for verifying an identity record.

Once an unverified identity record has been established, the data server (120) may, at a first step (302), submit a first data element associated with an unverified identity record to a first third party server (140). In the described embodiment, the first data element is a national identity number. The first third party entity may be a governmental or federal institution managing or controlling a national identity number database. In one exemplary embodiment, the first third party entity is Ideco.

The first third party server (140) receives the first data element in a following step (304) and identifies at least one additional data element associated with the first data element in a next step (306). The at least one additional data element is then transmitted to the data server in a following step (308).

At a next stage (310), the data server receives, from the first third party server, at least one additional data element. The received additional data elements may include one or more of the group of: a full name; initials; living/deceased status; residential address; and marital status.

In the described embodiment, the data server, at a further step (312), submits a second data element associated with the identity record to a second third party server (150). In this embodiment, the second data element is payment credentials. The second third party entity may be a financial institution. The second third party entity may, for example, be a financial institution having issued the payment credentials or alternatively, a payment clearing house system operator such as BankServ.

The second third party server then receives the second data element in a following step (314) and in a next step, identifies at least one further data element associated with the second data element in a next step (316). The at least one further data element is then transmitted to the data server in a following step (318).

The data server then receives from the second third party entity, in a following step (320), the at least one further data element being associated with the second data element at the second third party server. The received at least one further data element may include one or more of the group of: a full name; initials; residential address; national identity number; and a status of an associated financial account.

In a next step (322), the data server compares the received at least one additional data element with at least one corresponding data element associated with the identity record as well as the received at least one further data element with at least one corresponding data element associated with the identity record.

In some embodiments, if the received data elements match corresponding data elements associated with the identity record, the identity record is flagged as a verified identity record. However in other embodiments, the step (322) of comparing the received data elements with corresponding data elements includes a step (324) of associating a confidence indicator with the identity record.

The confidence indicator is related to the extent to which the received data elements match corresponding data elements. For example, where the received data element is a residential address of the user, it may be that small formatting differences exist meaning that in a strict sense (i.e. by comparing each character of the received data element with each character of the corresponding data element), the two data elements do not match exactly. Thus, the confidence indicator may be an indication of the percentage match.

If the confidence indicator exceeds a predetermined threshold, for example if the confidence indicator exceeds 75%, the data server (120) flags the identity record as a verified identity record in a following step (326).

In some embodiments, the data server (120) proceeds to initiate a payment having a specific attribute in favour of the financial account associated with the payment credentials in a next step (328). The specific attribute may be one or both of a specific amount and a specific payment reference. For example, the data server (120) may initiate a payment for R2.71 with a payment reference of TIM-98736362 (being unique to the user) in favour of the financial account.

The user is then prompted, for example by way of a message sent to the user's communication device, to submit an attribute in respect of the payment made in favour of the financial account. For example, the user may be prompted to review a bank statement and to submit a payment reference or a payment amount for the payment.

In a next step (330), the data server (120) receives, from the communication device (110) of the user, an indication of an attribute in respect of the payment made in favour of the financial account.

The data server (120) then, in a following step (332), compares the received attribute to the specific attribute and, if the received attribute matches the specific attribute, authenticates the identity record in a next step (334). In other embodiments, it may be that the identity record is only validated at this step (332) and not in response to determining that the confidence indicator exceeds a predetermined threshold.

Thus embodiments of the described systems and methods provide a data server for validating and authenticating an identity record. As such, users may utilise the data server for “know-your-customer” (KYC) purposes so as to verify their identity to entities such as business, financial institutions and the like.

In some cases KYC regulations require the information, particularly the residential address, to be recent. For example, it may be required for the residential address to have been validated within the last three months.

As such, further method steps may be provided, which may be repeated periodically, to update the validity of the residential address. FIG. 3B is a flow diagram which illustrates the further steps for periodically updating the validity of the residential address.

At a first step (352), the data server prompts a utility provider, or the user directly, for a utility bill associated with at least one data element of the identity record. The relevant data record may be the full name of the user or the residential address.

At a next step (354), the data server receives the utility bill from the utility provider.

The data server then, in a following step (356), uses a residential address provided with the utility bill to validate the residential address associated with the identity record.

In a next step (358), the data server identifies utility usage intimating user activity at the residential address. This may include identifying usage of the utility as compared with historic activity so as to determine whether or not the user is still resident at the residential address. If the data server identifies usage intimating user activity at the residential address the residential address is flagged, for a predefined period, as being active in a following step (360).

Thus the data server may be able to provide up-to-date KYC information for the user to interested parties.

Embodiments of the described systems and methods thus provide a central repository for KYC information which may be accessible to interested parties for the purposes of validating consumers. The described systems and methods may alleviate, at least to some extent, the burden experienced by some consumers in providing relevant KYC information to a plurality of interested parties when subscribing for services or goods.

It is foreseen that once a consumer's identity record has been verified, that the consumer may be requested whether the verified information may be released to requesting third parties. In this way, instead of resubmitting KYC information to each new entity with which a consumer wishes to transact, the consumer may simply refer the relevant entity to the central repository, which will in turn submit a request to the consumer to verify and approve the release of the verified account information to the interested third party. In this way the administrative burden on both the consumer and interested third party may be significantly reduced while remaining compliant with personal information protection legislation, such as the Protection of Personal Information Act in South Africa.

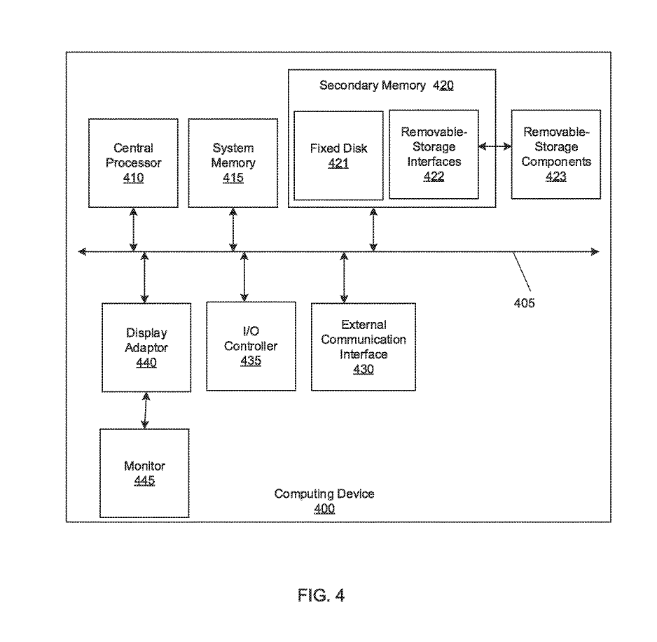

FIG. 4 illustrates an example of a server system (400) in which various aspects of the disclosure may be implemented. The server system (400) may be suitable for storing and executing computer program code. The various participants and elements in the previously described system diagrams may use any suitable number of subsystems or components of the server system (400) to facilitate the functions described herein.

The server system (400) may include subsystems or components interconnected via a communication infrastructure (405) (for example, a communications bus, a cross-over bar device, or a network). The server system (400) may include at least one central processor (410) and at least one memory component in the form of computer-readable media.

The memory components may include system memory (415), which may include read only memory (ROM) and random access memory (RAM). A basic input/output system (BIOS) may be stored in ROM. System software may be stored in the system memory (415) including operating system software.

The memory components may also include secondary memory (420). The secondary memory (420) may include a fixed disk, such as a hard disk drive (421), and, optionally, one or more removable-storage interfaces (422) for removable-storage components (423).

The removable-storage interfaces (422) may also be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (422) may also be in the form of ports or sockets for interfacing with other forms of removable-storage components (423) such as a flash memory drive, external hard drive, or removable memory chip, etc.

The server system (400) may include an external communications interface (430) for operation of the server system (400) in a networked environment enabling transfer of data between multiple server systems (400) or other computing devices. Data transferred via the external communications interface (430) may be in the form of signals, which may be electronic, electromagnetic, optical, radio, or other types of signal.

The external communications interface (430) may enable communication of data between the server system (400) and other server systems or computing devices, including external storage facilities. Web services may be accessible by the server system (400) via the communications interface (430).

The external communications interface (430) may also enable other forms of communication to and from the server system (400) including, voice communication, near field communication, Bluetooth, etc.

The computer-readable media in the form of the various memory components may provide storage of computer-executable instructions, data structures, program modules, components and other data. A computer program product may be provided by a computer-readable medium having stored computer-readable program code executable by the central processor (410).

A computer program product may be provided by a non-transient computer-readable medium, or may be provided via a signal or other transient means via the communications interface (430).

Interconnection via the communication infrastructure (405) allows a central processor (430) to communicate with each subsystem or component and to control the execution of instructions from the memory components, as well as the exchange of information between subsystems or components.

Peripherals (such as printers, scanners or the like) and input/output (I/O) devices (such as a mouse, touchpad, keyboard, microphone, joystick, or the like) may couple to the server system (400) either directly or via an I/O controller (435). These components may be connected to the server system (400) by any number of means known in the art, such as a serial port. One or more monitors (445) may be coupled via a display or video adapter (440) to the server system (400).

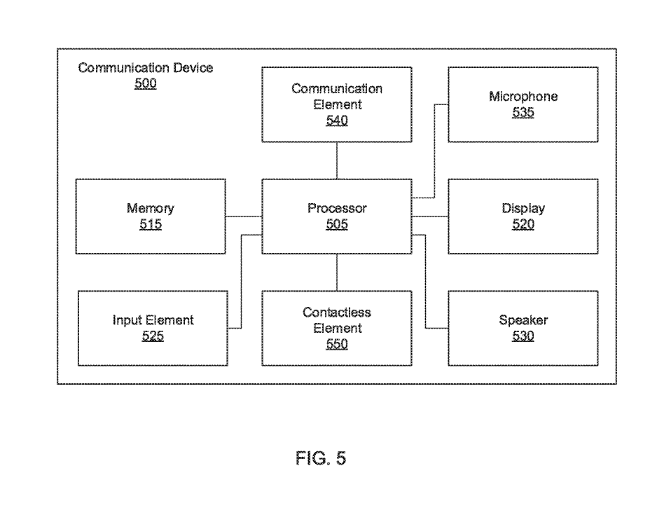

FIG. 5 shows a block diagram of a communication device (500) that may be used in embodiments of the disclosure. The communication device (500) may be a laptop computer, tablet computer, desktop computer, smart phones, smart appliances, cell phone, feature phone, satellite phone, or any other computing device with or without phone capability.

The communication device (500) may include a processor (505) (e.g., a microprocessor) for processing the functions of the communication device (500) and a display (520) to allow a user to see information and messages. The communication device (500) may further include an input element (525) to allow a user to input information into the device (e.g., input buttons, touch screen, etc.), a speaker (530) to allow the user to hear voice communication, music, etc., and a microphone (535) to allow the user to transmit his or her voice through the communication device (500).

The processor (510) of the communication device (500) may connect to a memory (515). The memory (515) may be in the form of a computer-readable medium that stores data and, optionally, computer-executable instructions.

The communication device (500) may also include a communication element (540) for connection to communication channels (e.g., a cellular telephone network, data transmission network, Wi-Fi network, satellite-phone network, Internet network, Satellite Internet Network, etc.). The communication element (540) may include an associated wireless transfer element, such as an antenna.

The communication element (540) may include a subscriber identity module (SIM) in the form of an integrated circuit that stores an international mobile subscriber identity and the related key used to identify and authenticate a subscriber using the communication device (500). One or more subscriber identity modules may be removable from the communication device (500) or embedded in the communication device (500).

The communication device (500) may further include a contactless element (550), which is typically implemented in the form of a semiconductor chip (or other data storage element) with an associated wireless transfer element, such as an antenna. The contactless element (550) may be associated with (e.g., embedded within) the communication device (500) and data or control instructions transmitted via a cellular network may be applied to the contactless element (550) by means of a contactless element interface (not shown). The contactless element interface may function to permit the exchange of data and/or control instructions between mobile device circuitry (and hence the cellular network) and the contactless element (550).

The contactless element (550) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (500) and an interrogation device. Thus, the communication device (500) may be capable of communicating and transferring data and/or control instructions via both a cellular network and near field communications capability.

The data stored in the memory (515) may include: operation data relating to the operation of the communication device (500), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (500) to selected receivers.

The communication device (500) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method for verifying an identity record, the method being conducted at a data server and comprising the steps of:
submitting, by a submitting component, a first data element associated with an unverified identity record to a first third party server;
receiving, by a receiving component, from the first third party server, at least one additional data element being associated, at the first third party server, with the first data element;
submitting, by the submitting component, a second data element associated with the unverified identity record to a second third party server;
receiving, by the receiving component, from the second third party server, at least one further data element being associated, at the second third party server, with the second data element;
comparing, by a comparing component, the received at least one additional data element and the received at least one further data element with at least corresponding data elements associated with the unverified identity record; and,
if the received at least one additional data element and the received at least one further data element matches the at least corresponding data elements, flagging, by a flagging component, the identity record as a verified identity record.

2. The method as claimed in claim 1, wherein the step of comparing the received data elements with corresponding data elements to includes:
associating, by a confidence associating component, a confidence indicator with the identity record, wherein the confidence indicator is related to the extent to which the received data elements match the corresponding data elements; and,
flagging, by the flagging component, the identity record as a verified identity record if the confidence indicator exceeds a predetermined threshold.

3. The method as claimed in claim 1, wherein the identity record has associated therewith one or more data elements of the group of: a full name; initials; national identity number; a residential address; a communication address; and payment credentials including a bank account number, a branch code and an account type.

4. The method as claimed in claim 1, wherein the first data element is a national identity number and the received at least one additional data element is one or more of the group of: a full name; initials; living/deceased status; residential address; and marital status.

5. The method as claimed in claim 1, wherein the second data element is payment credentials and the received at least one further data element includes one or more of the group of: a full name; initials; residential address; national identity number; and a status of an associated financial account.

6. A method as claimed in claim 5, which includes the steps of:
initiating, by an initiating component, a payment having a specific attribute in favour of the financial account associated with the payment credentials;
receiving, by a receiving component, from a communication device of a user, an indication of an attribute in respect of the payment made in favour of the financial account, the user having obtained the attribute from a bank statement or other transaction record relating to the financial account and accessible by the user ; comparing, by a comparing component, the received attribute to the specific attribute; and,
if the received attribute matches the specific attribute, authenticating the identity record.

7. A method as claimed in claim 6, wherein the specific attribute is one or both of a specific amount and a specific payment reference and the payment reference is unique to the user.

8. A method as claimed in claim 1, which includes the steps of:
receiving, by a receiving component, from a utility provider, a utility bill associated with at least one data element of the identity record;
validating, by a validating component, using a residential address provided with the utility bill, the residential address associated with the identity record;
identifying, by an identifying component, utility usage intimating user activity at the residential address; and,
flagging, by a flagging component, for a predefined period, the residential address as active.

9. A system for verifying an identity record, the system including a data server comprising:
a submitting component for submitting first and second data elements associated with an unverified identity record to first and second third party servers, respectively;
a receiving component for receiving, from the first and second third party servers, at least one additional data element and at least one further data element being associated, at the first and second third party servers respectively, with the first and second data elements;
a comparing component for comparing the received at least one additional data element and at least one further data element with at least corresponding data elements associated with the identity record; and,
a flagging component for, if the received at least one additional and further data elements match the at least one corresponding data element, flagging the identity record as a verified identity record.

10. The system as claimed in claim 9, wherein the data server includes an extracting component for extracting the first data element from the identity record.

11. The system as claimed in claim 9 or claim 10, wherein the comparing component includes a confidence associating component for associating a confidence indicator with the identity record, the confidence indicator being related to the extent to which the received data elements, including at least the additional and further data elements, match corresponding data elements and wherein the flagging component, if the confidence indicator exceeds a predetermined threshold, flags the identity record as a verified identity record.

12. The system as claimed claim 9, wherein the data server includes an initiating component for initiating a payment having a specific attribute in favour of a financial account associated with payment credentials, an indication receiving component for receiving, from a communication device of a user, an indication of an attribute in respect of the payment made in favour of the financial account, the user having obtained the attribute from a bank statement or other transaction record relating to the financial account and accessible by the user, an attribute comparing component for comparing the received attribute to the specific attribute, and an authenticating component for, if the received attribute matches the specific attribute, authenticating the identity record.

13. The system as claimed in claim 12, wherein the specific attribute is one or both of a specific amount and a specific payment reference and wherein the payment reference is unique to the user.

14. The system as claimed in claim 9, wherein the data server further includes a utility bill receiving component for receiving, from a utility provider, a utility bill associated with at least one data element of the identity record, a validating component for validating, using a residential address provided with the utility bill, the residential address associated with the identity record, an identifying component for identifying utility usage intimating user activity at the residential address, and wherein the flagging component flags, for a predefined period, the residential address as active.

15. A computer program product for verifying an identity record, the computer program product comprising a computer-readable medium having stored computer-readable program code for performing the steps of:
submitting a first data element associated with an unverified identity record to a first third party server;
receiving, from the first third party server, at least one additional data element being associated, at the first third party server, with the first data element;
submitting a second data element associated with the unverified identity record to a second third party server;
receiving, from the second third party server, at least one further data element being associated, at the second third party server, with the second data element;
comparing the received at least one additional data element and the received at least one further data element with at least corresponding data elements associated with the unverified identity record; and,
if the received at least one additional data element and the received at least one further data element matches the at least corresponding data element, flagging the identity record as a verified identity record.
